(19) United States
(12) Patent Application Publication
(10) Pub. No.: US 2003/0030501 A1
(43) Pub. Date: Feb. 13, 2003

(54) Housing assembly for multi-element surface-mount or drop-in circulator or isolator

(75) Inventors: George W. Hempel, Hanson, MA (US); Raymond G. Jussaume, Somerville, MA (US); Stanley V. Paquette, Dracut, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: TYCO ELECTRONICS CORPORATION

(21) Appl. No.: 10/067,583

(22) Filed: Feb. 4, 2002

Related U.S. Application Data
(60) Provisional application No. 60/311,707, filed on Aug. 10, 2001.

(51) Int. Cl. H01P 1/32

(52) U.S. Cl. 333/1.1; 333/24.2

(57) ABSTRACT

A multi-element radio frequency or microwave circulator or isolator assembly has a plurality of integral circuit elements in which the components are formed as single, unitary pieces arrayed in a stack in a single housing assembly. The housing assembly includes a base housing and a cover. The cover is configured to latch to the base housing in contact with the circuit elements to maintain a uniform operative pressure over the circuit elements in the housing assembly. In this manner, the components are maintained in a single dielectric medium and the dimensional tolerances in all elements are the same, leading to reduced losses and greater stability of performance.

### CROSS REFERENCE TO RELATED APPLICATIONS

This application claims the benefit under 35 U.S.C. § 119(e) of U.S. Provisional Application No. 60/311,707 filed on Aug. 10, 2001, the disclosure of which is incorporated by reference herein.

### STATEMENT REGARDING FEDERALLY SPONSORED RESEARCH OR DEVELOPMENT

N/A

### BACKGROUND OF THE INVENTION

Conventional radio frequency and microwave circulators are configured to provide a plurality of non-reciprocal signal transmission paths. For example, a radio frequency or microwave signal may travel through a conventional circulator in one direction along a particular transmission path with little loss, but may be greatly attenuated when applied to the transmission path from an opposite or reverse direction.

Such conventional radio frequency and microwave circulators typically include components made of ferrite material, which are exposed to a magnetic field to achieve the desired non-reciprocal operation. The magnetic field is set so that the applied signal suitably interacts with electrons within the ferrite components. Further, respective resonance frequencies are determined by the atomic makeup of the ferrite components and the net applied magnetic field. The non-reciprocal action of a ferrite component is then determined by the proximity of the applied signal frequency to the resonance frequency for that component.

Radio frequency and microwave circulators configured to provide non-reciprocal signal transmission paths are frequently employed as isolators. For example, such an isolator may be installed between a microwave oscillator and a load. The microwave oscillator may then deliver power to the load by way of the isolator, and any reflections from the load may subsequently be attenuated by the isolator to prevent them from reaching the oscillator. As a result, the microwave oscillator sees essentially constant load impedance, thereby making the oscillator less subject to frequency shifting caused by potential variations in the load impedance.

Additionally, in some applications, such isolators may be employed in place of buffer amplifiers to reduce power consumption and possibly manufacturing costs. Further, such isolators may be placed in line with an antenna of a receiver to prevent unwanted radiation of a local oscillator signal and/or provide impedance matching for a transmission line coming from the antenna.

Conventional circulators such as coaxial circulators and stripline circulators are commonly junction-type circulators, which generally comprise a center conductor sandwiched between two (2) ferrite disk components. The ferrite disks are typically placed between ground planes and magnetically biased by permanent magnets outside the ground planes. Further, connections between the junction-type circulators and external circuitry are typically made by a plurality of tabs.

Construction of the conventional single-element junction-type circulator may typically include providing metal disks or metalization on the ferrite components, and securing the permanent magnets to the respective ground planes using glue or epoxy. At least one screw clamp or solder is often employed to hold the circulator in place. Other construction methods employ locking rings in addition to the above-mentioned glue and screws to hold the circulator together while under pressure, thereby ensuring full internal contact of associated elements. However, this construction method has drawbacks in that it is usually slow and expensive, and may yield junction-type circulators having inconsistent performance and stability. A single-element housing is also known having a snap-on cover using tabs or louvers that fit within a slot on a base housing, and a dimple that exerts pressure on the components within the housing. See FIG. 8.

When two or more circulators or isolators are desired, an appropriate number of single-element devices each in its own housing are connected using an external connection that extends through air between the housings. Accordingly, the dielectric medium through which the signal travels varies from a ferrite medium to air and back to a ferrite medium. This variation in dielectric medium leads to losses. Also, even though each of the multiple devices may itself be manufactured within the appropriate dimensional tolerances, there are slight differences in tolerances between devices that lead to further losses.

### SUMMARY OF THE INVENTION

The present invention provides a multi-element circulator or isolator device that overcomes the deficiencies of connecting multiple single-element devices together with an external connection. The device includes a plurality of integral circulator or isolator circuit elements arrayed in a stack in a housing assembly. The center conductors or circuits are formed as a single, unitary piece with integral connections between circuits of the plurality of elements. The other components of the circuit elements are similarly formed as single, unitary pieces having a configuration to overlie and cover the plurality of circuits. In this manner, the circuits are retained in a single dielectric medium, preferably ferrite, and dimensional tolerances do not vary from element to element.

The housing assembly comprises a base housing and a cover that latches to the base housing. The housing assembly has an elongated shape configured to receive the integral circuit elements therein. The cover includes one or a plurality of dimples formed therein. The dimple or dimples are configured to exert a uniform operative pressure over the circuit elements when the cover is latched to the base housing.

In the presently preferred embodiment of a dual-element device, the cover of the housing assembly includes a top portion having a lip depending from the perimeter of the top portion. The top surface of the cover includes two dimples or depressions formed therein, each dimple associated with one or the plurality of circuit elements. The dimples are formed with a spring force biasing the central regions downwardly toward the components. In this way, when the components are assembled in the housing, the dimples are able to exert a downward pressure on the components to maintain the components in contact with no or minimal air gaps. In an alternative embodiment, a single, elongated dimple is provided that extends over the components of both elements.

The base housing includes a slot formed continuously in the outer face of the upstanding walls. Inwardly facing louvers or tabs are formed at intervals in the depending lip of the cover. When the cover is placed on the base housing, the free ends of the louvers catch in the slot of the cover, abutting the upper surface of the slot, to retain the cover on the housing. Alternatively, a number of discrete slots or depressions may be provided in locations corresponding to the louvers. In this way, the cover is held in a suitable position in which the dimple or dimples are able to maintain the desired operative pressure on the components in the housing. The device exhibits reduced losses and improved stability over prior art devices.

### DESCRIPTION OF THE SEVERAL VIEWS OF THE DRAWING

The invention will be more fully understood from the following detailed description taken in conjunction with the accompanying drawings in which:

FIG. 1 is an exploded isometric view of a dual-element circulator or isolator according to the present invention;

FIG. 2 is a bottom view of the cover of the dual-element circulator or isolator of FIG. 1;

FIG. 3 is a cross sectional view taken along line A-A of FIG. 2;

FIG. 4 is a side view of the cover of FIG. 2;

FIG. 5 is a partial cross-sectional view taken along line B-B of FIG. 4;

FIG. 6 is an isometric view of a further embodiment of a cover according to the present invention;

FIG. 7 is an isometric view of a further embodiment of a base housing according to the present invention; and

FIG. 8 is an exploded isometric view of a prior art single-element circulator or isolator.

### DETAILED DESCRIPTION OF THE INVENTION

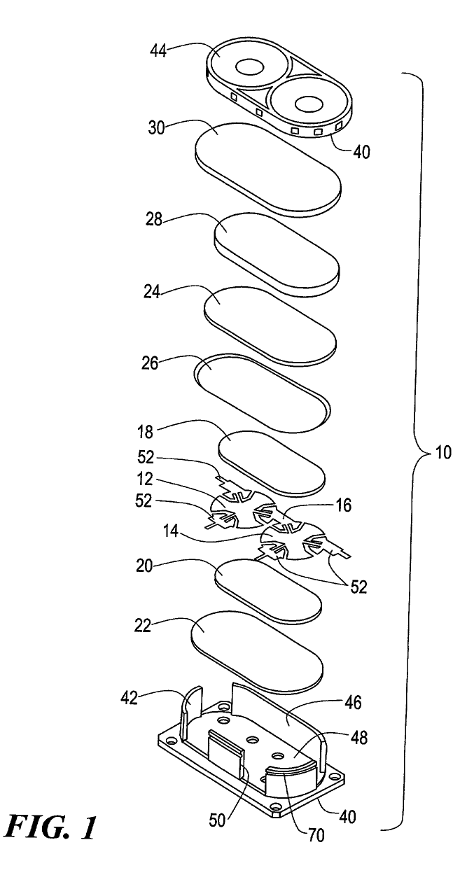

A multi-element circulator or isolator in a housing assembly according to the present invention is illustrated in FIG. 1. The device illustrated is a dual-element device 10 having two center conductors or circuits 12, 14, one circuit associated with each element of the device. The circuits are connected via an integral lead 16 to form a single, unitary piece. Although two circuits are shown, any desired plurality of circuits may be provided. A single, unitary upper ferrite slab 18 is disposed above the circuits, and a single, unitary lower ferrite slab 20 is disposed below the circuits. The ferrite slabs are in an oval or other elongated shape so that one upper slab and one lower slab cover both circuits. Other typical components of the circulator or isolator, such as pole pieces 22, 24, ground plane 26, magnet 28, and cover return 30 are also included in the assembly. These components are similarly formed as single, unitary pieces in an oval or other elongated shape to cover both circuits. The generally elongated shapes of the components are substantially the same to the extent that the components may be stacked in a vertical array in a compact and operative package and housed in a single housing assembly 40. Because the components are all formed as unitary pieces, the dimensional tolerances of both elements in the vertical or thickness direction are the same.

The components are assembled and encased in the housing assembly 40. The housing assembly is typically formed in two pieces: a base housing 42 and a cover 44. The base housing includes upstanding walls 46 in generally the oval or other elongated shape of the components to define an interior region 48 in which the ferrite slabs, the circuits, and the other components may be located with no or minimal shifting within the base housing 42. The walls 46 include cut away sections 50 through which the leads 52 of the circuits 12, 14 protrude. The housing assembly 40 is formed to exert a uniform operative pressure in the vertical direction on the components of both elements, as discussed further below.

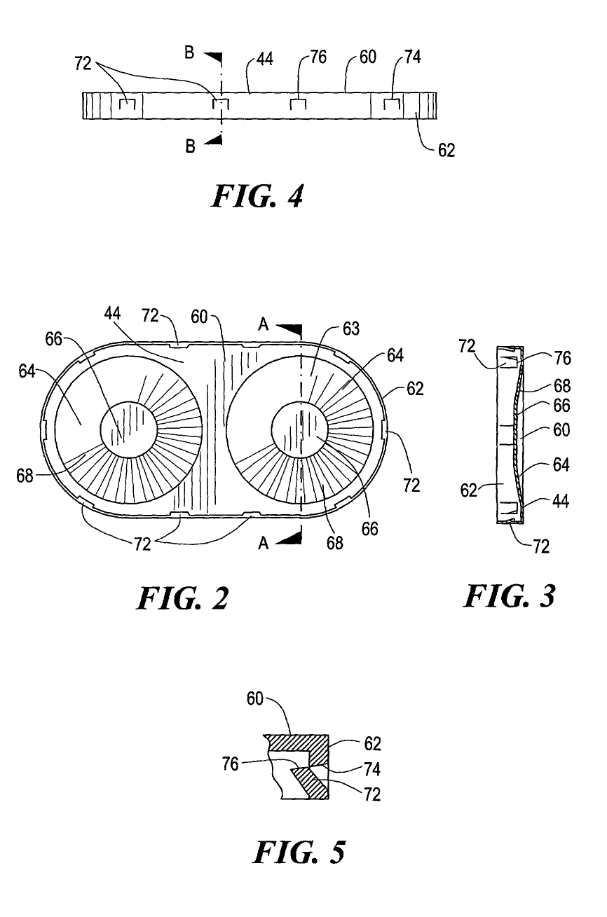

In the presently preferred embodiment, the cover 44 of the housing assembly includes a top portion 60 having a lip 62 depending from the perimeter of the top portion. See FIGS. 2-4. The top surface of the cover includes a dimpled region 63 having two dimples or depressions 64 formed therein. Each dimple has a generally flat central region 66 and a sloping annular region 68 surrounding the central region. The central regions are located generally over the center of the circuits 12, 14 when the components are assembled in the housing assembly 40. The dimples 64 are formed with a spring force biasing the central regions 66 downwardly toward the components. In this way, when the components are assembled in the housing, the dimples are able to exert a downward pressure on the components to maintain the components in contact with no or minimal air gaps. The cover is preferably formed by stamping a sheet of a suitable metal, such as a steel, in a die, which creates the lip 62 and the dimples 64. The stamping action stretches the metal of the cover in the annular region of the dimples, giving the dimples the spring force and downward bias necessary to exert pressure on the circuit and the other components when the cover is retained on the base housing. The pressure should be sufficient to eliminate or minimize air gaps between the components, but not so great as to crack the ferrite slabs 18, 20.

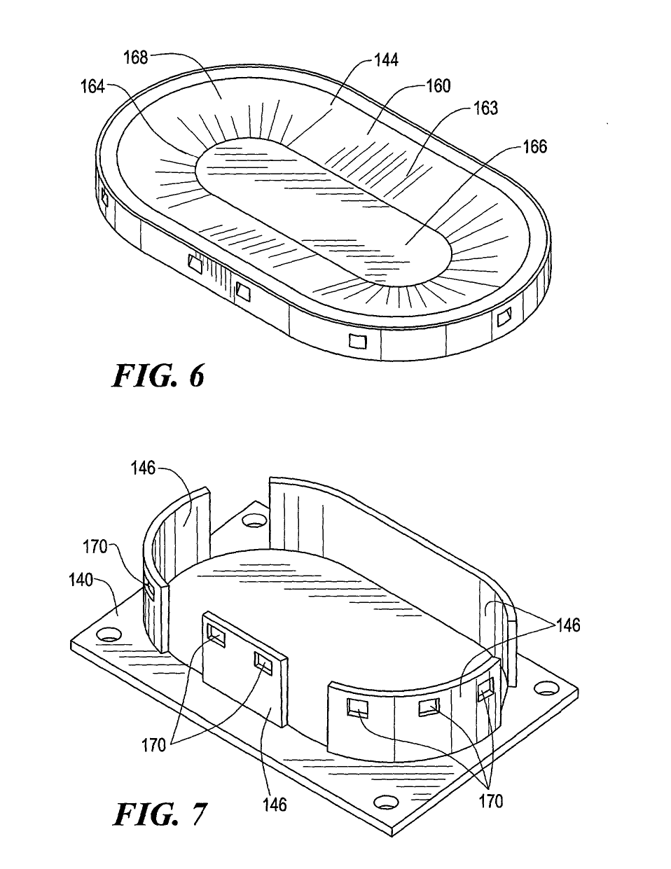

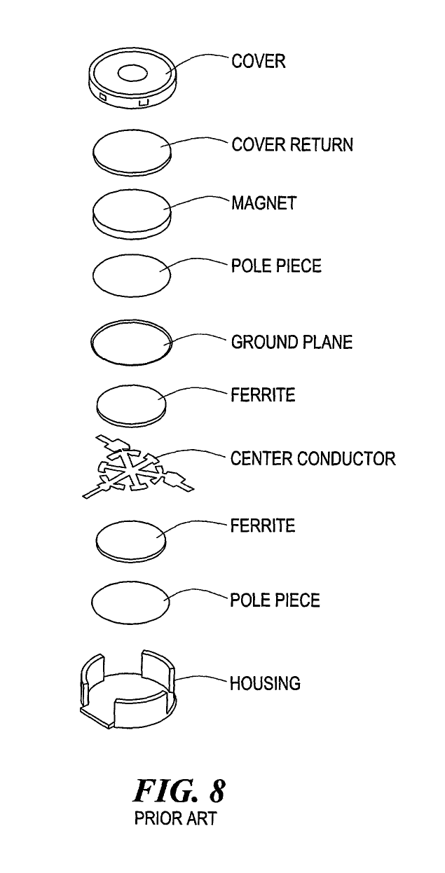

FIG. 6 illustrates an alternative embodiment of a cover 144 of the housing assembly. The cover 144 includes a dimpled region 163 in a top portion 160, in which the dimpled region has a single, elongated dimple 164 that extends over the components of both elements. The single dimple has a generally flat oval or other elongated central region 166 and a sloping annular region 168 surrounding the central region. The central region is elongated sufficiently to extend over the center of the circuits 12, 14 when the components are assembled in the housing assembly. The dimple 164 is formed with a spring force biasing the central region downwardly toward the components, thereby maintaining a downward pressure on the components to maintain the components in contact with no or minimal air gaps, as described above.

The base housing 42 includes a slot 70 formed in the outer face of the upstanding walls. See FIG. 1. Inwardly facing louvers or tabs 72 are formed at intervals in the depending lip 62 of the cover 44. See FIGS. 2-5. The louvers 72 comprise an area defined by slits 74 through the lip 62 that is pushed or bent inwardly to form an upwardly and inwardly directed free end 76. The louvers may be formed in any suitable manner, such as by punching, after the cover is stamped. When the cover 44 is placed on the base housing 42, the free ends 76 of the louvers 72 catch in the slot 70 of the base housing, abutting the upper surface of the slot, to retain the cover on the housing. In this way, the cover is held in a suitable position in which the dimples are able to maintain the desired pressure on the components in the housing.

In the embodiment of FIG. 1, the slot 70 is continuous in the upstanding walls of the base housing. In a further embodiment, illustrated in FIG. 7, a base housing 144 includes a plurality of discrete slots 170 or recessed areas or cut outs at locations in the upstanding walls 146 corresponding to the louvers in the cover.

Forming the components of both elements of the isolator or circulator of the present invention as single components eliminates the need for separate housings, one for each circuit, with a separate conductor extending through air between the two circuits. In this manner, the signal stays in the same dielectric medium provided by the ferrite slabs. By maintaining the circuits in the same dielectric medium, losses are reduced and the performance of the device becomes more stable. In addition, by forming the components within the housing as single components, the dimensional tolerances of the thickness of each component are the same for both elements of the device. Thus, there is no variation in tolerance between the two circuits. A difference in these tolerances from circuit to circuit, as in the separate prior art devices, can lead to losses and reduced performance of the device. Similarly, maintaining the same uniform pressure over both elements reduces losses and improves the stability of the device's performance.

It will be appreciated that the housing assembly of the present invention can be configured to house three or more circulators or isolators. Other configurations of the housing assembly capable of providing a uniform pressure over the plurality of elements within the housing assembly may be provided. The invention is not to be limited by what has been particularly shown and described, except as indicated by the appended claims.

What is claimed is:

1. A multi-element radio frequency or microwave circulator or isolator assembly comprising:
a plurality of integral circulator or isolator circuit elements arrayed in a stack; and
a housing assembly, the circuit elements disposed in the housing assembly, the housing assembly comprising:
a base housing,
a cover, the cover configured to latch to the base housing,
the housing assembly further having an elongated shape configured to receive the integral circulator or isolator circuit elements therein, and
the cover further including a dimpled region extending over the plurality of circuit elements and comprising at least one dimple formed therein configured to exert a uniform operative pressure over the circuit elements therein when the cover is latched to the base housing.

2. The assembly of claim 1, wherein:
the cover further comprises:
a top portion, and
a lip depending from a perimeter of the top portion; and
the dimpled region is formed in the top portion, the dimpled region comprising at least one generally flat central region and a sloping annular region surrounding the central region and formed with a spring force biasing the central region downwardly into contact with the plurality of circuit elements.

3. The assembly of claim 1, wherein:
the cover further comprises:
a top portion, and
a lip depending from a perimeter of the top portion; and
the dimpled region is formed in the top portion, the dimpled region comprising a single, elongated dimple comprising a generally flat central region and a sloping annular region surrounding the central region and formed with a spring force biasing the central region downwardly into contact with the circuit elements.

4. The assembly of claim 1, wherein:
the cover further comprises:
a top portion, and
a lip depending from a perimeter of the top portion; and
the dimpled region is formed in the top portion, the dimpled region comprising a plurality of dimples, each dimple associated with one of the plurality of circuit elements, each dimple comprising a generally flat central region and a sloping annular region surrounding the central region and formed with a spring force biasing the central region downwardly into contact with the associated one of the plurality of circuit elements.

5. The assembly of claims 2, 3, or 4, wherein:
the base housing further comprises:
upstanding walls, and
a slotted region formed in an outer face of the upstanding walls; and
the lip of the cover includes a plurality of inwardly facing louvers disposed to latch within the slot in the base housing to retain the cover on the base housing.

6. The assembly of claim 5, wherein the slotted region comprises a slot formed continuously in the outer face of the upstanding walls.

7. The assembly of claim 5, wherein the slotted region comprises a plurality of discrete slots formed in the outer face of the upstanding walls, the discrete slots located to correspond to the plurality of louvers.

8. The assembly of claim 1, wherein:
the base housing further comprises:
upstanding walls, and
a slotted region formed in an outer face of the upstanding walls; and
the cover further comprises:
a top portion, and
a lip depending from a perimeter of the top portion, and
a plurality of inwardly facing louvers formed in the lip and having a free end disposed to latch within the slotted region in the base housing.

9. The assembly of claim 8, wherein the slotted region comprises a slot formed continuously in the outer face of the upstanding walls.

10. The assembly of claim 8, wherein the slotted region comprises a plurality of discrete slots formed in the outer face of the upstanding walls, the discrete slots located to correspond to the plurality of louvers.

11. The assembly of claim 1, wherein the pressure is selected to minimize air gaps in the stack.

12. The assembly of claim 1, wherein the pressure is selected to be less than a pressure sufficient to crack components of the circuit elements.

13. The assembly of claim 1, wherein the circuit elements include:
a plurality of interconnected center conductors;
an upper ferrite slab above the conductors;
a lower ferrite slab below the conductors; and
a magnet above the conductors and the upper ferrite slab;
the upper ferrite slab, the lower ferrite slab, and the magnet each having an elongated shape configured to cover the conductors, each elongated shape being substantially the same and configured to fit within the elongated shape of the housing assembly.

14. A multi-element radio frequency or microwave circulator or isolator assembly comprising:
a plurality of integral circulator or isolator circuit elements comprising a plurality of components, each component formed as a single, unitary piece, arrayed in a stack; and
a housing assembly, the circuit elements disposed in the housing assembly, the housing assembly comprising:
a base housing, and
a cover, the cover configured to latch to the base housing in contact with the circuit elements to maintain a uniform operative pressure over the plurality of circuit elements in the housing assembly.

15. The assembly of claim 14, wherein each of the components are formed with an elongated shape sufficient to allow stacking of the components in the housing assembly and to provide a single dielectric medium in the housing.

16. The assembly of claim 15, wherein the dielectric medium comprises a ferrite medium.

17. The assembly of claim 14, wherein the circuit elements include:
a plurality of interconnected center conductors;
an upper ferrite slab above the conductors;
a lower ferrite slab below the conductors; and
a magnet above the conductors and the upper ferrite slab;
the upper ferrite slab, the lower ferrite slab, and the magnet each having an elongated shape configured to cover the conductors, each elongated shape being substantially the same and configured to fit within the elongated shape of the housing assembly.
